(19) United States
(12) Patent Application Publication
(10) Pub. No.: US 2011/0102616 A1
(43) Pub. Date: May 5, 2011

(54) DATA STRUCTURE FOR STILL IMAGE FILE, IMAGE FILE GENERATION DEVICE, IMAGE REPRODUCTION DEVICE, AND ELECTRONIC CAMERA

(75) Inventors: Go MIGIYAMA, Kawasaki-shi (JP); Koichi GOHARA, Kawasaki-shi (JP); Hideo HIBINO, Yamato-shi (JP)

(73) Assignee: NIKON CORPORATION, Tokyo (JP)

(21) Appl. No.: 12/860,261

(22) Filed: Aug. 20, 2010

(30) Foreign Application Priority Data
Aug. 28, 2009 (JP) 2009-198096

(51) Int. Cl. H04N 5/228; G06F 17/30

(52) U.S. Cl. 348/222.1; 707/809; 348/E05.031; 707/E17.005

(57) ABSTRACT

A moving image generation unit generates moving image data of a predetermined resolution based on a pixel signal from an imaging element and stores the moving image data in a RAM. For example, when a still image is captured while a moving image is being captured, a still image generation unit generates still image data of, for example, full resolution based on the pixel signal from the imaging element. Then, an image extraction processing unit extracts moving image data for n seconds before and after the time the still image is captured from the moving image data stored in the RAM. A file generation unit incorporates the extracted moving image file in a header of the still image file to generate a moving image-added still image file.

### BACKGROUND OF THE INVENTION

The present invention relates to a data structure of a still image file, an image file generation device that generates a still image file, an image reproduction device that reproduces an image based on a still image file, and an electronic camera.

In the prior art, one type of an electronic camera captures still images while capturing moving images, generates a data structure including associating data for associating a file for the still images with a file for the moving images, and records (saves) the two image files associated with each other. The associating data includes the file name of the associated image file as an identifier (for example, refer to Japanese Laid-Open Patent Publication number 2004-304425). The electronic camera of the publication includes a function that displays a moving image mark when reproducing a still image to inform a user of the presence of moving images that have been captured simultaneously with a still image. The electronic camera also includes a function for reproducing the moving images corresponding to the still image from a reproduction point corresponding to the capturing timing of the reproduced still image when a predetermined operation is performed.

### SUMMARY OF THE INVENTION

The file name of an image file may be rewritten by a user. In the electronic camera described in Japanese Laid-Open Patent Publication number 2004-304425, when the file name of one or both of the image files associated with each other by the associating data is rewritten, the rewritten file name would differ from the file name used as the identifier in the associating data. In this case, the associated moving images and still images cannot be identified due to the file name that is used as the identifier in the associating data. Generally, the moving images for effectively reproduce a still image using moving image data associated with the reproduction of the still image requires a relatively short reproduction time (e.g., approximately ten seconds), which includes the capturing time of the still image.

One aspect of the present invention provides a still image file data structure including a single still image file incorporating still image data, information related to the still image data, and moving image data associated with the still image data.

Another aspect of the present invention provides an image file generation device for use with an image capturing means capable of capturing a still image while capturing a moving image, with the image file generation device generating a still image file. The image file generation device includes an image retrieval means for retrieving moving image data of the moving image captured by the image capturing means and for retrieving still image data of the still image captured by the image capturing means while capturing the moving image. An information retrieval means retrieves information related to the still image data that is retrieved. A file generation means generates a single still image file including the information, the moving image data, and the still image data.

A further aspect of the present invention provides an image reproduction device for reproducing an image based on a still image file having the data structure of the above aspect. The image reproduction device includes a display unit, a speaker, a selection means for selecting a still image file that is to be reproduced, an audio data retrieval means for retrieving audio data from the moving image data of the selected still image file, and a control means for reproducing the still image data in the selected still image file as an image displayed on the display unit and reproducing the audio data at a reproducing timing synchronized with the still image data.

A further aspect of the present invention provides an image reproduction device. The image reproduction device includes a storage means for storing a plurality of still image files including at least one still image file having the data structure of the above aspect, a display unit, a display control means for generating a selection page displaying in a list a plurality of images based on the plurality of still image files read from the storage means and displaying the selection page on the display unit, a selection means for selecting one or more still images that are to be reproduced from the plurality of images in the displayed list on the selection page, and a reproduction means for performing image reproduction to display the one or more still images selected by the selection means on the display unit. Among the still image files used for the displayed list, for a still image file including moving image data, the display control means displays a moving image based on the moving image data as an image in the displayed list.

The present invention provides an electronic camera including one or both of the above-described image file generation device and the image reproduction device.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of a camera;

FIG. 2 is a rear view of the camera;

FIG. 3 is a block diagram illustrating the electrical structure of the camera;

FIG. 4 is a block diagram of an image file generation device and image reproduction device that are incorporated in the camera;

FIG. 5 is a schematic diagram illustrating the data structure of moving image data;

FIG. 6 is a schematic diagram illustrating the data structure of a moving image-added still image file;

FIG. 7 is a flowchart illustrating an image file generation processing routine;

FIG. 8 is a screen diagram illustrating a selection page for a still image file;

FIG. 9 is a flowchart illustrating a still image multi-display processing routine;

FIG. 10 is a schematic diagram illustrating slideshow processing;

FIG. 11 is a flowchart illustrating a slideshow processing routine;

FIG. 12 is a rear view illustrating the camera when a still image of a slideshow is being displayed; and

FIG. 13 is a rear view illustrating a camera with the content of a modification displayed on a monitor.

### DESCRIPTION OF THE EMBODIMENTS

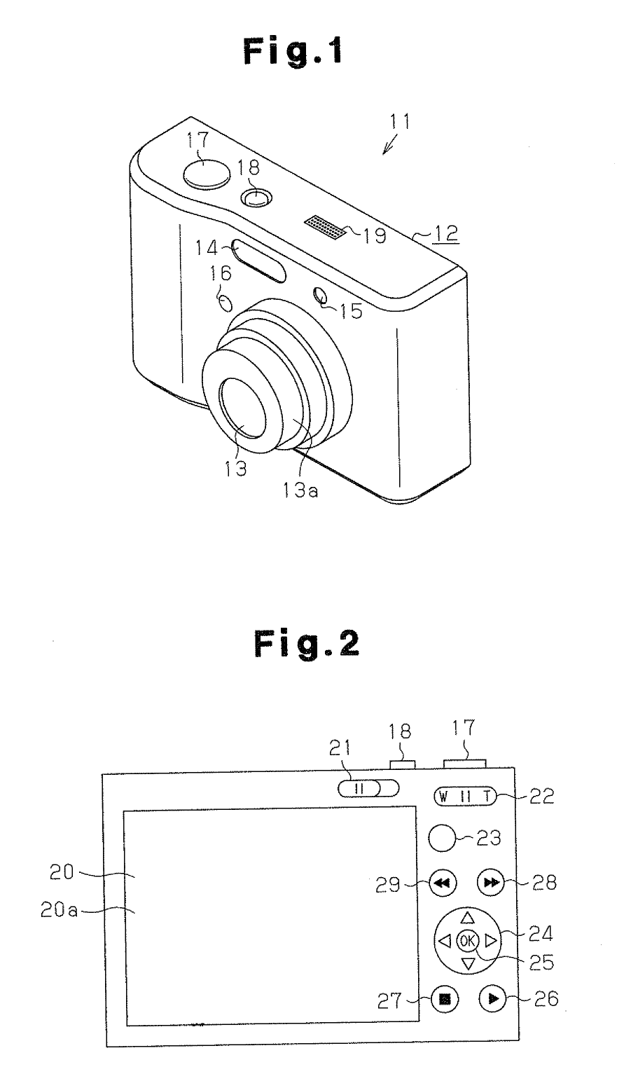

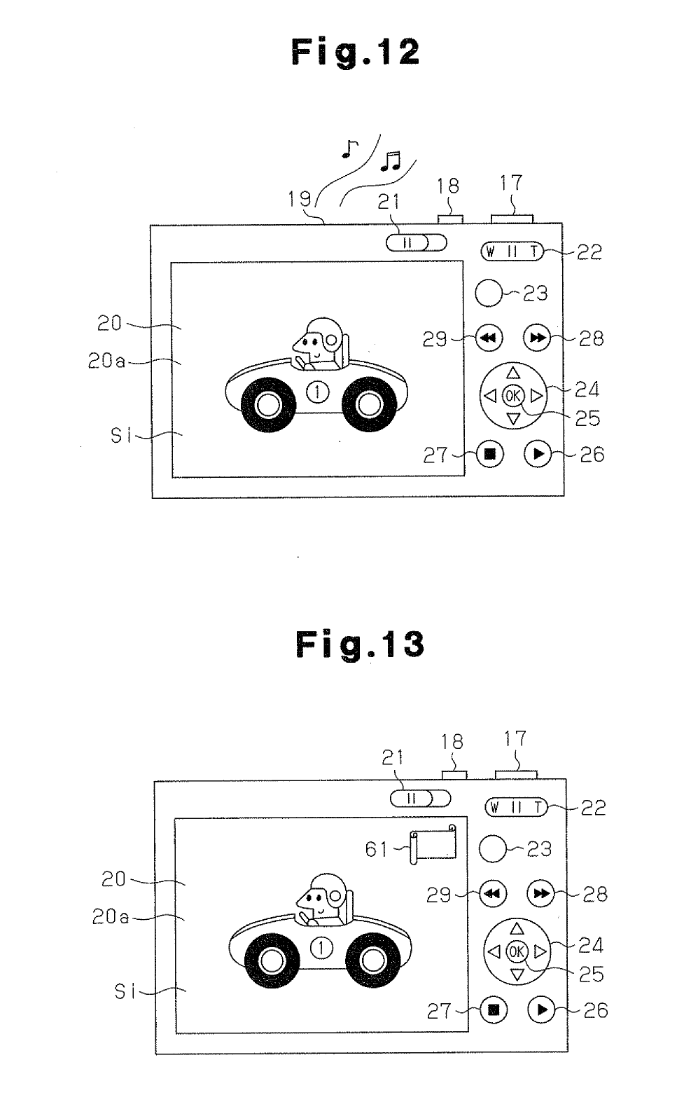

A digital camera, which is one type of an electronic camera according to one embodiment of the present invention, will now be discussed with reference to FIGS. 1 to 12.

FIG. 1 is a perspective view of a digital camera 11, and FIG. 2 is a rear view. As shown in FIG. 1, the distal camera (hereinafter referred to as the “camera”) 11 includes a camera body 12, which is generally box-shaped. A telescopic barrel 13a incorporating an imaging lens unit 13 is arranged in the front central part of the camera body 12. A strobe light 14 and an emission window 15 are arranged above the barrel 13a. The emission window 15 emits focusing infrared light toward an object. A microphone 16 is also arranged near the barrel 13a to record sound.

The camera body 12 has an upper surface on which are arranged from the left a shutter button 17, a power button 18, and a speaker 19. The shutter button 17 is pressed down (i.e., on operation) by a user to start an imaging operation with the camera 11. The power button 18 is pressed down by the user when turning on the power of the camera 11. The camera 11 of the present embodiment includes a moving image capturing function in addition to a still image capturing function. The speaker 19 outputs the sound recorded by the microphone 16 when capturing moving images.

As shown in FIG. 2, the camera body 12 has a rear surface in which a monitor 20 is arranged. A mode selection switch 21 is arranged above the monitor 20. The operation mode of the camera 11 is switchable between a still image mode and a moving image mode by switching the mode selection switch 21. When the shutter button 17 is pressed down to capture moving images, the camera 11 of the present embodiment functions to capture a still image at the same time as when capturing moving images (hereinafter referred to as the moving image/still image simultaneous capturing function). The monitor 20 is, for example, a liquid crystal monitor.

The rear surface of the camera body 12 further includes a zoom button 22, a menu button 23, a selection button 24, and an enter button 25.

The zoom button 22 is mainly operated to zoom in or zoom out with the imaging lens unit 13. The menu button 23 is mainly operated to display a menu page on the monitor 20. When the user operates the menu button 23, a menu button is displayed in accordance with the present operation mode. Further, the selection button 24 is mainly operated to select an item from the menu page, switch setting pages, and change settings. The enter button 25 is operated to enter (determine) an item selected from a menu page or setting page. For example, when the user designates the quantity of displayed images and selects the item of multi-display on the menu page, images (still images or moving images) corresponding to the present operation mode (still image mode or moving image mode) are shown as a displayed list (multi-display) on a screen 20a of the monitor 20. For example, in the still image mode, a plurality of miniaturized still images are shown in the displayed list. The user operates the selection button 24 to select one of the images from the displayed list. This enables reproduction of the selected image.

The rear surface of the camera body 12 further includes a reproduction button 26, a stop button 27, a fast forward button 28, and a fast reverse button 29. For example, when the user operates the reproduction button 26 in the still image mode, the presently selected still image is displayed (reproduced) on the screen 20a. When the user operates the reproduction button 26 in the moving image mode, the presently selected moving image is reproduced on the screen 20a.

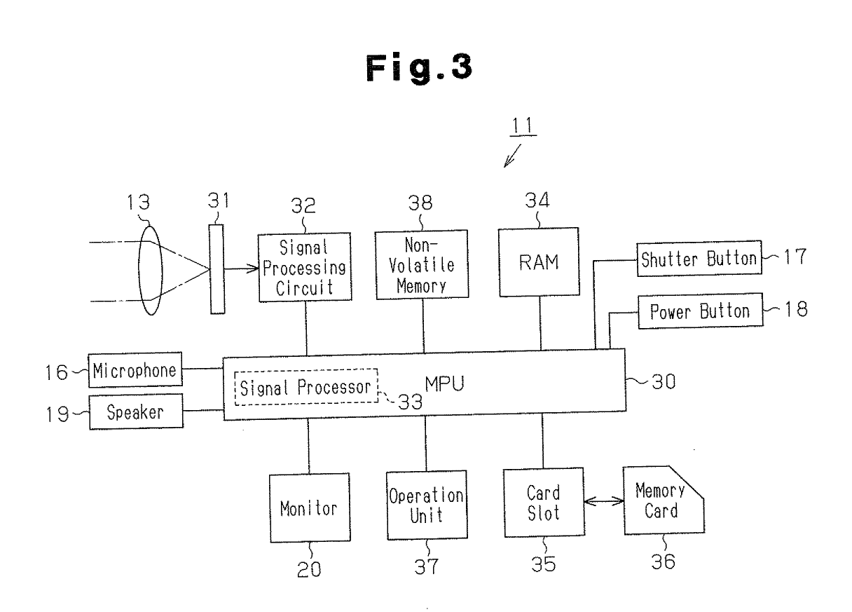

The circuit structure of the camera 11 according to the present embodiment will now be discussed with reference to the block diagram of FIG. 3.

As shown in FIG. 3, the camera 11 includes a micro processing unit (MPU) 30 that centrally controls various operations of the camera 11. The camera 11 includes in the camera body 12 an imaging element 31 that focuses object light, which has passed through the lenses (only one shown in FIG. 1 for the sake of brevity) of the imaging lens unit 13, at an image space side of the imaging lens unit 13. The imaging element 31 may be a complementary metal oxide semiconductor (CMOS) image sensor or a charge coupled device (CCD) image sensor. The imaging element 31 stores a signal charge corresponding to an object image focused onto its imaging plane, photo-electrically converts the stored signal charge to generate an analog signal, and outputs the generated analog signal as a pixel signal. In a standby mode after the power button 18 is pressed down and before the shutter button 17 is pressed down, the imaging element 31 outputs pixel signals for a through-the-lens image in which the object continuously changes.

The imaging element 31 is connected in series to the signal processing circuit 32. The signal processing circuit 32 includes an analog front end (AFE) and an A-D converter. The AFE samples the pixel signals output from the imaging element 31 at predetermined timings (correlated double sampling) and amplifies the pixel signals to a predetermined signal level based on, for example, the ISO sensitivity. The A/D converter converts an amplified pixel signal output from the AFE to a digital signal. Then, the A/D converter sends the digital image signal to the MPU 30.

The MPU 30 incorporates an image processor 33 (e.g., digital signal processor (DSP)), which performs predetermined image processing. The image processor 33 performs image processing, such as color interpolation, gray level correction, white balance, and contour correction, on a digital pixel signal received from the signal processing circuit 32 to generate predetermined image data. The image data generated by the image processor 33 is temporality stored in a RAM 34, which is formed by a DRAM or the like and functions as a buffer memory.

Then, the MPU 30 reads the image data from the RAM 34 and performs data compression using, for example, the JPEG method to generate image file including the compressed image data. The MPU 30 then stores the generated image file via a card slot 35 in a memory card 36, which is a recording medium that is removable from the camera 11. Further, the MPU 30 reads the image data from the memory card 36 and decompresses the image data, which is stored in the RAM 34 and displayed on the monitor 20 via an LCD drive circuit (not shown).

Further, as shown in FIG. 3, the shutter button 17, the power button 18, the monitor 20, and an operation unit 37 are connected to the MPU 30. The operation unit 37 includes the mode selection switch 21, the zoom button 22, the menu button 23, the selection button 24, the enter button 25, the reproduction button 26, the stop button 27, the fast forward button 28, and the fast reverse button 29, which are shown in FIG. 2. The monitor 20 selectively displays moving images and still images in accordance with the display control of the MPU 30.

The MPU 30 is connected to an automatic exposure device (AE device), an autofocus device (AF device), a shutter controller and the like. The MPU 30 controls these devices to execute automatic exposure control (AE control), autofocus control (AF control), shutter control, and the like. Further, the MPU 30 executes the aforementioned controls (e.g., image capturing control, data processing control, and display control) in accordance with a control program code stored in, for example, a non-volatile memory 38.

The image processor 33 has an image file generation function that will now be described. The camera 11 includes the moving image/still image simultaneous capturing function to allow for still images to be captured when capturing moving images. When still images are captured while moving images are being captured and a still image file is generated, the image file generation function extracts moving image data corresponding to n seconds (n being a value ranging, for example from two to ten seconds) before and after a still image capturing time ts. Then, the image file generation function incorporates a still image header in the extracted moving image file to generate a still image file.

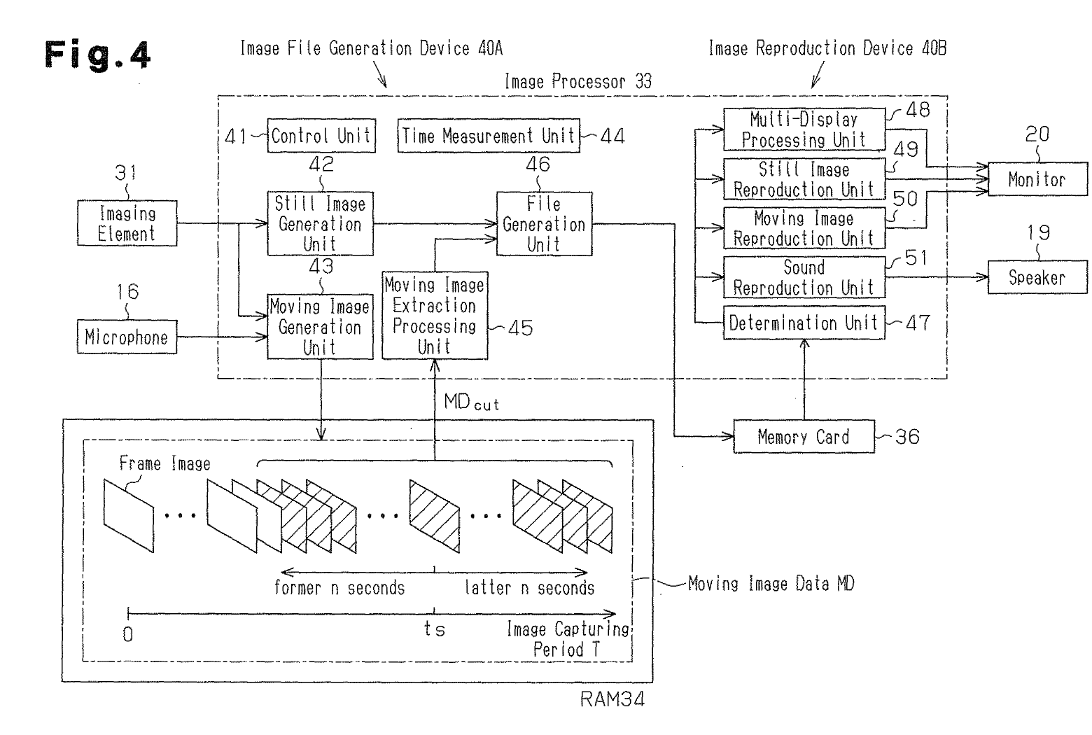

FIG. 4 shows the structure of an image file generation device and an image reproduction device. As shown in FIG. 4, an image file generation device 40A and an image reproduction device 40B are formed by the image processor 33, the RAM 34, etc. The image processor 33 includes an image file generation function, which generates an image file based on the image data generated by image-processing the received pixel signal, and an image reproduction function, which reproduces an image based on the image file. To realize the image file generation function and the image reproduction function, the image processor 33 includes a control unit 41 that centrally controls each part, a still image generation unit 42, a moving image generation unit 43, a time measurement unit 44, a moving image extraction processing unit 45, a file generation unit 46, a determination unit 47, a multi-display processing unit 48, a still image reproduction unit 49, a moving image reproduction unit 50, and a sound reproduction unit 51. In the present embodiment, the image file generation device 40A is formed by the control unit 41, the still image generation unit 42, the moving image generation unit 43, the time measurement unit 44, the moving image extraction processing unit 45, the file generation unit 46, and the RAM 34. The image reproduction device 40B is formed by the determination unit 47, the multi-display processing unit 48, the still image reproduction unit 49, the moving image reproduction unit 50, and the sound reproduction unit 51.

When capturing a still image in the still image mode, for example, an image signal for full resolution (approximately ten megapixels) is provided from the imaging element 31 to the still image generation unit 42 in the image processor 33 via the signal processing circuit 32 (refer to FIG. 3). Further, when capturing a moving image in the moving image mode, a pixel signal from the imaging element 31 generated when capturing a moving image and a sound signal from the microphone 16 are provided at a synchronized timing to the moving image generation unit 43 in the image processor 33.

The still image generation unit 42 performs predetermined image processing on the received full resolution pixel signal to generate still image data. Further, the moving image generation unit 43 generates moving image data based on the received pixel signal and sound signal. Then, the moving image generation unit 43 stores (saves) the generated moving image data in a predetermined storage region of the RAM 34. In detail, the moving image generation unit 43 generates in a predetermined frame rate (e.g., 30 fps) a frame image having a resolution that is lower than the full resolution by performing predetermined image processing on the pixel signal received when capturing moving images. In synchronism with the pixel signal, the moving image generation unit 43 generates audio data based on the sound signal received from the microphone 16. Then, the moving image generation unit 43 sequentially stores (saves) the generated frame image and audio data in a predetermined storage region of the RAM 34. In one example, the resolution is set to full resolution (approximately 10 megapixels) for the still image data although the set resolution may be varied to a lower resolution. The resolution for moving image data is lower than the resolution set for still image data and may be, for example, a video graphics array (VGA) (640×840 pixels) or quarter video graphics array (QGVA) (320×240 pixels).

The time measurement unit 44 includes a time function for obtaining the present time and a moving image capture period measuring function for measuring the capture period of moving images from when the capturing of moving images starts. The still image capturing time or the moving image capturing time stored in the header of a still image file or a moving image file is retrieved from the time information of the time measurement unit 44 at the point of time image capturing starts.

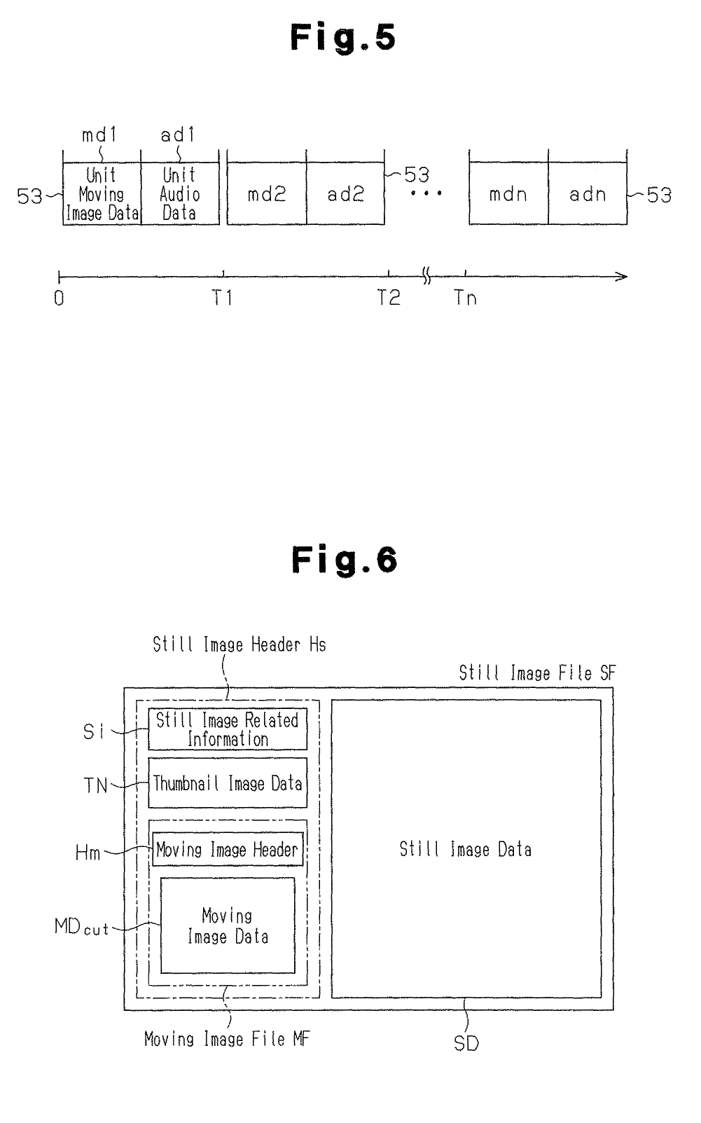

FIG. 5 illustrates the structure of moving image data, which is generated by the moving image generation unit 43. As shown in FIG. 5, unit moving image data md, which is formed by a predetermined number of frame images, and unit audio data ad, which is synchronized with the unit moving image data md, are contained in a single container 53. The moving image generation unit 43 sequentially stores the generated containers 53 in a predetermined storage region of the RAM 34. In this manner, moving image data is stored in the RAM 34. As shown in FIG. 5, in each container, image capturing time that sets “0” as the moving image capturing start time is recorded as a time stamp. For example, the unit moving image data md1, md2, . . . , mdn are recorded whenever a predetermined time interval ΔT elapses with the time stamps of the capturing times “0”, “T1”, “Tn”. Thus, by searching through the time stamps of the containers 53 in the moving image data MD, the container 53 for the desired time may be extracted (retrieved).

When a still image is captured, the still image capturing time ts is retrieved from the time measured by the time measurement unit 44. Thus, by comparing the still image capturing time ts with the time stamp (image capturing time) of each container 53 in the moving image data MD, which is stored in the RAM 34, and searching for the time stamp corresponding to the still image capturing time ts, a frame image group corresponding to n seconds before the still image capturing time ts and a frame image group corresponding to n seconds after the still image capturing time ts may be extracted.

Whenever the camera 11 captures a still image while capturing moving images, the control unit 41 instructs the moving image extraction processing unit 45 to perform an extraction process on moving image data. The moving image extraction processing unit 45, which becomes active when receiving an instruction from the control unit 41, performs a process for extracting moving image data MDcut corresponding to n seconds before and after the still image capturing time (i.e., 2n seconds) from the moving image data MD stored in the RAM 34 by the moving image generation unit 43. The extraction process is performed by searching through the time stamps of the containers 53 in the moving image data MD, locating the container 53 for the image capturing period in the range of the n seconds before and after the still image capturing time ts, and reading the located container 53 to extract the moving image data MDcut.

FIG. 6 illustrates the data structure of a moving image-added still image file SF. As shown in FIG. 6, the moving image file SF includes a still image header Hs and still image data SD. In the same manner as a typical still image file, the header Hs includes captured still image related information related to the still image data, thumbnail image data TN (miniaturized still image data), etc. The captured still image related information includes the capturing date and time (year/date/hour/minute/second), the capturing conditions (shutter speed, exposure value, zoom value, image capturing mode, posture angle, etc.), and the image capturing information (GSP information etc.). The moving image file MF is incorporated in the header Hs. The moving image file MF includes a moving image header Hm and the moving image data MDcut extracted by the moving image extraction processing unit 45.

The resolution (e.g., VGA or QVGA) of the moving image data MDcut is lower than the resolution set for the still image data SD (e.g., 10 megapixels). Further, the image capturing time of the moving image data MDcut is limited to the n seconds before and after the still image capturing time ts (2n seconds). Thus, the data volume of the moving image data MDcut is small enough such that it can be incorporated in the header Hs. By incorporating the moving image file MF in the header Hs of the still image file SF, the still image data and the moving image data that are associated with each other are stored in a single still image file SF.

The generation of the moving image-added still image file has been described above for the moving image/still image simultaneous capturing function. However, even in the still image mode, by selecting the item of “moving image-included file generation” from the menu, a moving image-added still image file SF may be generated in the same manner.

In this case, the image processor 33 retrieves pixel signals for full resolution (approximately 10 megapixels) from the imaging element 31 from the imaging element 31. This retrieval is performed constantly or from the occurrence of a predetermined triggering (e.g., slight shutter button pressing). Then, the image processor 33 continuously stores the moving image data MDcut for the low resolution of VGA or QVGA over a predetermined time (e.g., time ranging from 10 seconds to 60 seconds). Then, when the shutter button 17 is fully pressed before the predetermined time elapses thereby generating a still image capturing trigger, the control unit 41 instructs the still image generation unit 42 to generate still image data and instructs the moving image extraction processing unit 45 to extract moving image data MDcut.

The file generation unit 46 receives the still image data SD for full resolution captured at the still image capturing time is from the still image generation unit 42. Further, the file generation unit 46 receives the moving image data MDcut corresponding to the n seconds before and after the still image capturing time is extracted by the moving image extraction processing unit 45 from the moving image data MD stored in the RAM 34. Then, the file generation unit 46 adds a header Hs to the still image data SD to generate a still image file, adds a moving image header Hm to the moving image data MDcut to generate a moving image file MF, and incorporates the generated moving image file MF in the header Hs to generate a moving image-added still image file SF. The file generation unit 46 stores the moving image-added still image file SF in the memory card 36.

Further, the file generation unit 46 shown in FIG. 4 generates a moving image file based on the moving image data MD stored in the RAM 34 during the moving image mode. The file generation unit 46 generates a still image file based on the still image data when the item of “moving image-included file generation” is not set during the still image mode.

The structure of the image reproduction device 40B, which reproduces an image based on an image file stored in the memory card 36 will now be described. Referring to FIG. 4, as described above, the image reproduction device 40B includes the control unit 41, the determination unit 47, the multi-display processing unit 48, the still image reproduction unit 49, the moving image reproduction unit 50, and the sound reproduction unit 51, which are arranged in the image processor 33. In the present embodiment, the memory card 36 stores three types of image files, still image file, moving image files, and moving image-added still image file SF. Accordingly, there are two types of still image files, which differ in whether or not the header Hs includes a moving image file MF (or moving image data MDcut).

When reproducing a still image and when processing a multi-display, the determination unit 47 determines whether or not the still image file that is read from the memory card 36 for reproduction is a moving image-added still image file SF. More specifically, the determination unit 47 reads from the memory card 36 the still image file instructed to be reproduced by the control unit 41 and determines whether or not the header Hs of the read still image file includes moving image data MDcut. When the header Hs includes moving image data MDcut, the determination unit 47 determines that the still image file is a moving image-added still image file SF. When the header Hs does not include moving image data MDcut, the determination unit 47 determines that the still image file is a simple still image file.

To prompt the user to select the still image or moving image that is to be reproduced, the multi-display processing unit 48 performs a process for generating a selection page that multi-displays a plurality of images and a display process for displaying the generated selection page on the monitor 20. In the present example, the display process for multi-displaying a plurality of images in the selection page is also broadly included in an image reproduction process. Here, the multi-display selection page is shown in accordance with the present operation mode. More specifically, in the still image mode, still image files are selected as the subjects for multi-display. In the moving image mode, moving image files are selected as the subjects for the multi-display. For simple still image files, the thumbnail image data TN (refer to FIG. 6) is the subject for multi-display. For moving image-added image file SF, the moving image data MDcut in the header Hs is the subject of multi-display.

When displaying a selection page during the still image mode, if the determination unit 47 determines that the still image file subject to display is a moving image-added still image file SF, the multi-display processing unit 48 of the present example shows on the selection page a moving image based on the moving image data MDcut in the header Hs. If the determination unit 47 determines that the still image file subject to display is a simply still image file, the multi-display processing unit 48 shows on the selection page a thumbnail image based on the thumbnail image data TN in the header Hs.

The still image reproduction unit 49 performs a still image reproduction process for reproducing on the monitor 20 a single still image selected by the user, for example, from the selection page.

The moving image reproduction unit 50 performs a moving image reproduction process for reproducing on the monitor 20 a single moving image selected by the user, for example, from the selection page.

When a moving image is reproduced, the sound reproduction unit 51 reproduces sound based on the audio data in the moving image data in synchronism with the moving images reproduced on the monitor 20 by the image reproduction unit 50.

The image reproduction device 40B further includes a slideshow function, which is one of the image reproduction functions. The slideshow is a function for sequentially switching the still images shown on the monitor 20. The user performs an operation for selecting a plurality of still image files and then performs an operation for instructing execution of a slideshow. In response to the slideshow execution instruction, the control unit 41 activates the determination unit 47, the still image reproduction unit 49, and, when necessary, the sound reproduction unit 51. The control unit 41 designates the order in which the still image files are reproduced and then instructs the still image reproduction unit 49 to display the still images on the monitor 20. This executes the slideshow that sequentially displays the still images on the monitor 20. Here, the control unit 41 has the determination unit 47 first read the instructed still image files from the memory card 36 and then determine whether or not moving image data MDcut is included in the header Hs of each read still image file.

When the determination unit 47 determines that moving image data MD is included in the header Hs, the control unit 41 activates the still image reproduction unit 49 and the sound reproduction unit 51. Then, the control unit 41 reproduces a still image based on the still image data SD in the still image file SF with the still image reproduction unit 49 and reproduces sound based on the audio data in the moving image data MDcut of the header Hs.

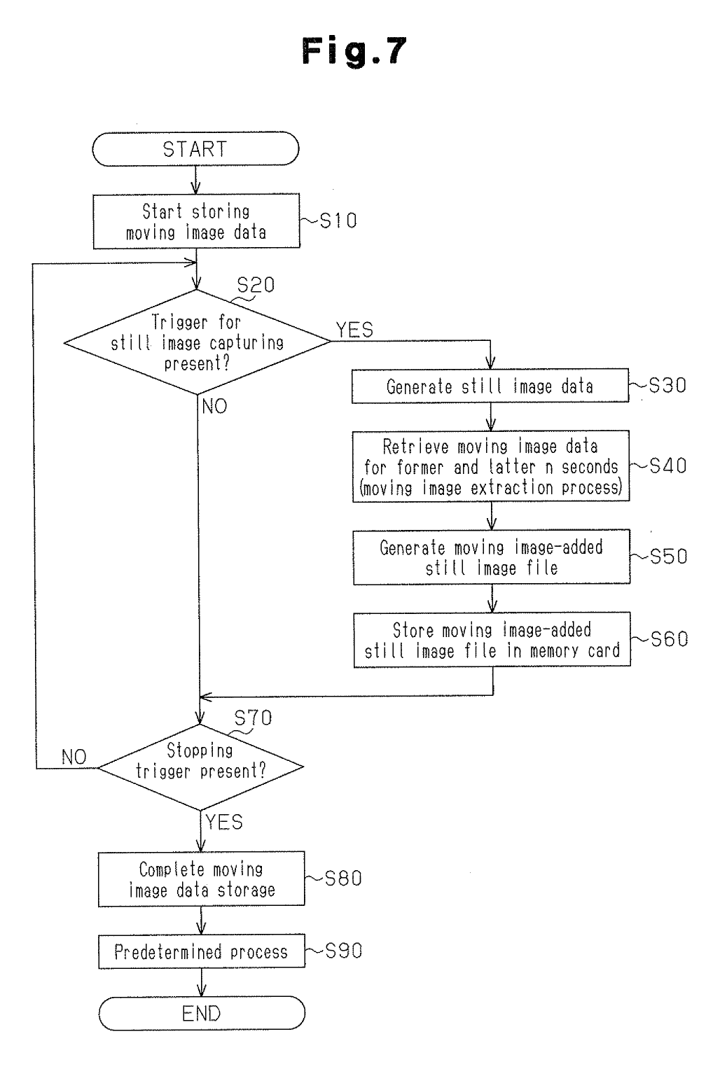

In the present example, the circuits of the image file generation device 40A (excluding the RAM 34) may be realized as software by having the MPU 30 execute the program of an image file generation processing routine, which is illustrated in the flowchart of FIG. 7 and stored in the non-volatile memory 38. The image reproduction device 40B also includes a still image multi-display function unit and a slideshow processing function unit. The still image multi-display function unit (control unit 41, determination unit 47, and multi-display processing unit 48) in the image reproduction device 40B may be realized as software by having the MPU 30 execute the program codes of a still image multi-display processing routine, which is illustrated in the flowchart of FIG. 9 and stored in the non-volatile memory 38. Further, the slideshow processing function unit (control unit 41, determination unit 47, still image reproduction unit 49, and sound reproduction unit 51) in the image reproduction device 40B may be realized as software by having the MPU 30 execute the program codes of a slideshow processing routine, which is illustrated in the flowchart of FIG. 11 and stored in the non-volatile memory 38. It is obvious that the realization of the image file generation device 40A and the image reproduction device 40B is not limited to the execution of software and may be realized by hardware formed by an ASIC etc. or through the cooperation of software and hardware.

The outlines of the image file generation processing routine executed by the MPU 30 of the camera 11 will now be discussed with reference to FIG. 7.

In a state in which the power button 18 of the camera 11 is turned on, the MPU 30 starts the image file generation processing routine shown in FIG. 7 using an operation for starting the capturing of moving images in the moving image mode as a trigger or a slight shutter button pressing operation (image capturing preparation operation) in the still image mode as a trigger. In step S10, the MPU 30 receives an image signal for a high resolution that varies as time elapses for the present object image focused on the image capturing plane of the imaging element 31. In a non-restrictive example, the resolution of the pixel signal may be full resolution. Based on the received high resolution pixel signal, the moving image generation unit 43 in the MPU 30 generates moving image data for a low resolution such as VGA or QVGA and starts storing the generated moving image data in the RAM 34.

Next, in step S20, the MPU 30 determines whether or not a still image capturing trigger has been generated, that is, whether or not the shutter button 17 has been fully pressed. When there is a still image capturing trigger, the control flow proceeds to step S30. When there is no still image capturing trigger, the control flow proceeds to step S70. For example, when the user presses the shutter button 17 at time ts and captures a still image, the control flow proceeds to step S30.

In step S30, the MPU 30 activates the moving image extraction processing unit 45 and extracts moving image data MDcut corresponding to the n seconds before and after the still image capturing time ts from the moving image data MD stored in the RAM 34. In this manner, the MPU 30 retrieves the moving image data MDcut from the RAM 34 (moving image extraction process).

Next, in step S50, the MPU 30 activates the file generation unit 46 and generates moving image-added still image file SF with the file generation unit 46. The file generation unit 46 retrieves the captured still image related information from the control unit 41, incorporates the captured still image related information in the header Hs of a file, and adds the header Hs to the still image data SD to generate a still image file. Then, the file generation unit 46 retrieves captured moving image related information from the control unit 41, incorporates the captured moving image related information in a moving image header Hm, and adds the moving image header Hm to the moving image data MDcut to generate a moving image file MF. Finally, the file generation unit 46 incorporates the moving image file ME in the header Hs of the still image file SF and completes a moving image-added still image file SF. It is obvious that the order for incorporating the captured still image related information, the moving image data, and the captured moving image related information may be changed as required.

Next, in step S60, the file generation unit 46 stores the moving image-added still image file SF in the memory card 36.

When the MPU 30 determines in step S20 that there is no still image capturing trigger, the MPU 30 proceeds to step S70 and determines whether or not a stopping trigger has been generated. For example, when a moving image is being captured, an operation for stopping the capturing of the moving images corresponds to the stopping trigger. Further, in the still image mode, the generation of the stopping trigger is determined when a predetermined time (for example, a value in the range of 10 to 60 seconds) elapses from the slight shutter button pressing operation (image capturing preparation) without a full pressing operation being performed. In this case, the MPU 30 determines whether or not the predetermined time has elapsed from the time measurement information of the time measurement unit 44, which measures the elapsed time from the slight shutter button pressing operation. The MPU 30 then returns to step S20 when there is no stopping trigger. Subsequently, the storage of the moving image data is continued until a still image capturing trigger is generated in S20 (affirmative determination in S20) or a stopping trigger is generated in S70 (affirmative determination in S70).

When determining that a stopping trigger has been generated in step S70, the MPU 30 proceeds to step S80 and ends the storage of moving image data to the RAM 34.

Next, in step S80, the MPU 30 performs a predetermined process that is performed after a stopping trigger is generated. For example, when the stopping trigger is an operation for stopping the capturing of moving images, the control unit 41 in the MPU 30 activates the file generation unit 46 to generate a moving image file based on the moving image data stored in the RAM 34 with the file generation unit 46. Then, the file generation unit 46 stores the generated moving image file in the memory card 36. When in the still image mode, the MPU 30 deletes the moving image data stored in the RAM 34. In this manner, when a predetermined process is completed before completion, the MPU 30 ends the image file generation processing routine.

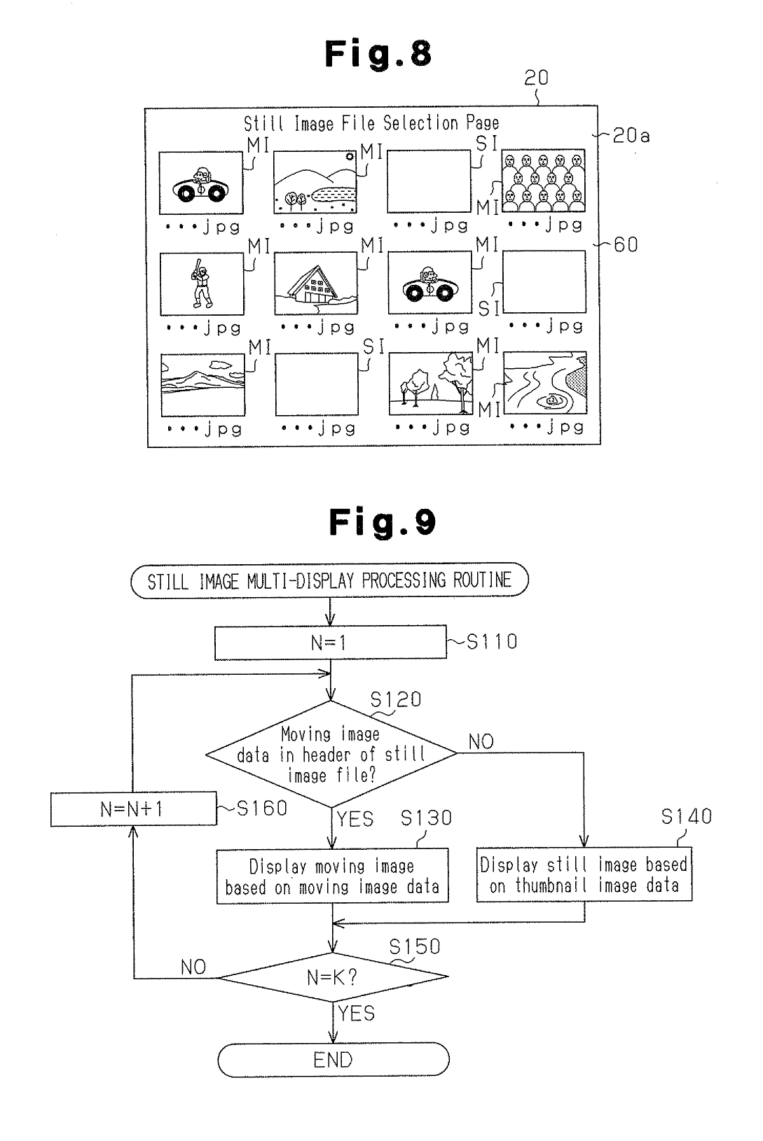

Next, multi-display processing will be described with reference to FIGS. 4 and 8 and in accordance with the flowchart of FIG. 9.

When the item of “multi-display” is selected from the menu page for the still image mode, the MPU 30 executes the multi-display processing routine of FIG. 9. When multi-display is selected, the MPU 30 retrieves a display quantity K of the images that are to be multi-displayed as designated by the user.

First, in step S110, the MPU 30 sets a number N, which indicates the still image that should be reproduced, to the initial value of “1”

Next, in step S120, the MPU 30 activates the determination unit 47 and determines whether or not the header Hs of the still image file for a designated image includes moving image data MDcut. The determination unit 47 determines whether or not the header Hs of the still image file for the designated image includes moving image data. When determined that the header Hs includes moving image data, that is, when the designated image is a moving image-added still image file SF, the control flow proceeds to step S130. When determined that the header Hs does not include moving image data MDcut, that is, when the designated image is a simple still image file, the control flow proceeds to step S140.

In step S130, the MPU 30 activates the moving image reproduction unit 50 and shows a moving image, which is based on the moving image data MDcut in the header Hs, with the moving image reproduction unit 50 at the display position for N=1 in the selection page.

In step S140, the MPU 30 displays a still image based on thumbnail image data for a simple still image file, which that does not include moving image data in the header Hs, at the display position for N=1 in the selection page.

In step S150, the MPU 30 determines whether or not N=K is satisfied. That is, the MPU 30 determines whether or not the display of all the images in the display quantity K has been completed. When the display of the images in the display quantity K is not completed, the MPU 30 proceeds to step S160 to increment N to N+1. The MPU 30 then returns to step S120, and performs the processes of step S120 and step S130 or 140 on the second image. In accordance with whether the second image is a moving image-added still image file SF, a moving image (step S130) or a still image (step S140) is shown at the display position for N=2 in the selection page. In this manner, whenever a moving image or a still image is displayed as a display position corresponding to the value of N, N is incremented by “1”, and the moving image or still image is displayed in order at the display position corresponding to the incremented value of N. When the displaying of all of the images for the display quantity K is completed, N=K is satisfied in step S150 (affirmative determination in step S150), and the MPU 30 ends the still image multi-display processing routine in the still image mode.

As a result of the MPU 30 executing the still image multi-display processing routine, a still image file selection page 60, in which images are multi-displayed as shown in FIG. 8, is displayed on the screen 20a of the monitor 20. As shown in FIG. 8, in the selection page 60, low resolution moving images MI are displayed for moving image-added still image files SF, and thumbnail still images SI are displayed for simple still image files.

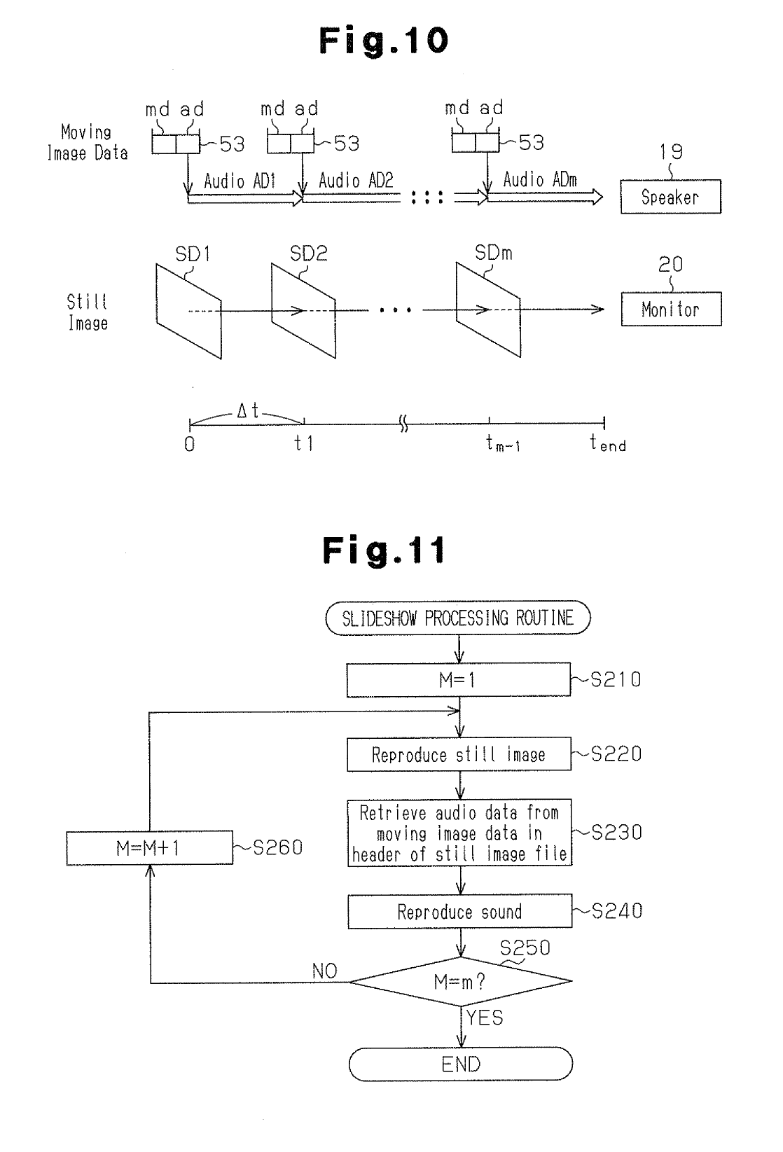

The slideshow will now be discussed. FIG. 10 is an explanatory diagram illustrating slideshow processing, and FIG. 11 shows a slideshow processing routine. When the user performs a slideshow execution instruction operation, the MPU 30 performs the slideshow execution instruction operation of FIG. 11. When the user wishes to use the slideshow function, after performing an operation for selecting still image files used in a slideshow, for example, from the still image file selection page 60 shown in FIG. 8 or after selecting a folder storing still images, the user performs an operation for instructing execution of the slideshow. When selecting a slideshow still image file from the selection page 60 shown in FIG. 8, the user checks whether the multi-displayed images in the selection page 60 is a moving image or a still image to determine whether an image is for a moving image-added image file SF or a simple still image file.

In the slideshow function of the present embodiment, a still image slideshow is performed for a moving image-added still image file SF. In this case, audio data is extracted from the container 53 forming moving image data in the header Hs to reproduce the sound with the speaker 19 based on the audio data in synchronism with the display of the corresponding still image. When the user wishes to use this function, the user selects the still image file that is displayed as a moving image in the selection page 60.

First, in step S210, M=1 is set. Here, M is number data (counter data) indicating the order of a still image in the slideshow and is incremented from M=1 to a quantity m of the still images designated for the slideshow. When processing the first still image, M=1 is set in S210.

Next, in step S220, a still image is reproduced. More specifically, the control unit 41 in the MPU 30 retrieves the still image data in the Mth (e.g., first) still image file and instructs the still image reproduction unit 49 to reproduce the still image based on the retrieved still image data. In response to the instruction, the still image reproduction unit 49 reproduces the still image on the monitor 20 based on the received still image data.

In step S230, the MPU 30 retrieves audio data from the moving image data in the header of the still image file. When there is a possibility of a simple still image file, which is not a moving image-added still image file SF, being included in the still image files in the designated group of files or folder, the determination unit 47 of the MPU 30 determines whether or not moving image data is included in the headers of the still image files. When moving image data is included, the MPU 30 retrieves the audio data from the container 53 including the moving image data.

In step S240, the MPU 30 reproduces sound based on the retrieved audio data. More specifically, the control unit 41 in the MPU 30 reproduces sound with the sound reproduction unit 51 based on the retrieved audio data in synchronism with the display of the slideshow for the presently reproduced still image. The sound reproduction unit 51 reproduces the sound instructed by the control unit 41 to reproduce sound from the speaker 19 in correspondence with the still image that is being displayed on the monitor 20.

In step S250, it is determined whether or not M=m is satisfied. As described above, M is the quantity of images used in the slideshow. Thus, it is determined whether or not M=m is satisfied to determine whether or not the display of all of the still images that should be displayed in the slideshow has been completed. When M=m is satisfied, the routine is completed. When M-m is not completed, still image files that should be displayed are remaining. Thus, the MPU 30 proceeds to step S260, increments M (M=M+1), and then returns to step S220.

In this manner, whenever the display of a single still image in synchronism with the reproduction of the corresponding sound ends during the slideshow, the MPU 30 proceeds to the next ((M+1)th) still image file and reproduces the still image for the next still image file (S220). Then, the MPU 30 retrieves the audio data corresponding to the reproduced still image (S230) and performs synchronized sound reproduction based on the audio data. When the display of the slideshow for all of the still image files in the slideshow is completed and M=m is satisfied in step S250, the routine is completed.

Execution of the slideshow processing routine continues the display of a still image over a predetermined period (t) as shown in FIG. 10. During the period in which the display of the still image is continued, the speaker 19 (refer to FIG. 1) reproduces sound based on the audio data in the container 53 of the moving image data corresponding to the reproduced still data. The reproduced still image is switched to the next still image whenever reaching a predetermined switching timing. This performs the slideshow that sequentially displays the m still images on the monitor 20.

The present embodiment discussed above has the advantages described below.

(1) The moving image-added still image file SF has a data structure in which thumbnail image data TN (thumbnail still image) and a moving image file MF are incorporated in the header Hs. This allows for easy location of the moving image data MD associated with still image data.

(2) The resolution of the moving image data MD incorporated in a header Hs is lower than the resolution of the still image data SD. Thus, even if the moving image data includes a plurality of frame images, the moving image data may be incorporated in the header Hs. Further, the moving image data MD is retrieved by extracting the moving image data (frame images) corresponding to the n seconds before and after the still image capturing time ts so that the moving image data MD fits into the header Hs. Thus, the moving image data MD may always be incorporated in the header Hs, which has a data volume that is smaller than the data volume of the still image data SD.

(3) Further, the moving image data MD in the header Hs includes audio data. Thus, for example, when reproducing a still image, the associated sound may also be reproduced.

(4) When multi-displaying still image files on the selection page 60, for a moving image-added still image file SF, the multi-display processing unit 48 reproduces a moving image based on the moving image data in the header Hs. This allows for the user to check the moving image for a predetermined time (e.g., n seconds) before and after the still image capturing time ts to appropriately determine whether the still image file is the desired one before reproducing it. Thus, file selection errors are reduced. Accordingly, unnecessary selection operations may be reduced since the correct still image file does not have to be re-selected.

(5) When generating the multi-display selection page 60, the determination unit 47 determines whether the still image files displayed on the selection page 60 are still image files SF including moving image data MD in the headers Hs. When a still image file is a moving image-added still image file SF including moving image data MD, the multi-display processing unit 48 displays a moving image based on the moving image data MD in the header Hs. When a still image file is a simple still image file that does not include moving image data, the multi-display processing unit 48 displays a still image based on the still image data. In this manner, even when moving image-added still image files SF and simple still image files are both included as multi-displayed still image files, for a moving image-added still image file SF, a moving image based on the moving image data MD in the header Hs is shown as a single image on the selection page 60.

(6) The capturing of a still image when capturing moving images using the moving image/still image capturing function in the moving image mode and the capturing a still image in the still image mode are triggers for generating a moving image-added still image file SF. Thus, moving image-added still image files SF may be generated for both of the moving image mode and the still image mode.

(7) For example, when capturing a still image while capturing moving images with the moving image/still image capturing function, the image file generation device 40A starts storing moving image data in the RAM 34 from when the capturing of moving images starts. At a point of time a still image is captured (trigger generation time), the image file generation device 40A extracts moving image data MDcut for the n seconds before and after the still image capturing time ts from the stored moving image data. Then, the image file generation device 40A incorporates the moving image data MDcut in a header Hs to generate a moving image-added still image file SF. In comparison with, for example, a structure that stores moving image data (through-the-lens image) in the RAM 34 from when switching to the moving image mode, the present embodiment stores only the necessary moving image data in the RAM 34. Thus, unnecessary moving image data is not stored in the RAM 34.

(8) Further, for example, in the still image mode, the image file generation device 40A starts storing the moving image data (through-the-lens image) in the RAM 34 from when a slight shutter button pressing operation (image capturing preparation operation) is performed. At a point of time a still image is captured (trigger generation time), the image file generation device 40A extracts moving image data MDcut for the n seconds before and after the still image capturing time ts from the stored moving image data. Then, the image file generation device 40A incorporates the moving image data MDcut in a header Hs to generate a moving image-added still image file SF. In comparison with, for example, a structure that stores moving image data (through-the-lens image) in the RAM 34 from when switching to the still image mode, the present embodiment stores only the necessary moving image data in the RAM 34. Thus, unnecessary moving image data is not stored in the RAM 34.

(9) When executing a slideshow, the image reproduction device 40B reproduces a still image on the monitor 20 based on the still image data SD in the moving image-added still image file SF that is subject to the slideshow. During the reproduction of the still image, the image reproduction device 40B also reproduces sound corresponding tot eh reproduced still image based on the audio data that forms the moving image data MD in the header Hs. This allows for the user to enjoy the slideshow together with sound. Here, the still image data and the audio data are stored in the same file. Thus, the image reproduction device 40B easily retrieves the audio data that corresponds to the reproduced still image data. For example, when still image data and moving image data are managed in separate files, a process for searching for the moving image file associated with the still image file would be necessary. However, the data structure of the present embodiment eliminates the need for such a searching process and allows for the moving image data (or audio data) associated with still image data to be easily retrieved.

The above-discussed embodiment may be modified to other forms as described below.

The function for synchronously reproducing corresponding sound when reproducing a still image with a moving image-added still image file SF is not limited to the slideshow. For example, a structure may be employed in which the speaker 19 reproduces sound based on the audio data corresponding to a still image when the still image is reproduced on the monitor 20 during a normal still image reproduction mode in which still images displayed on the monitor 20 are switched whenever a user operates the selection button 24 of the operation unit 37. In this structure, a still image may be checked together with the sound recorded with the microphone 16 when the still image was captured. Further, for a still image file of which sound has been reproduced, a noise may be used to announce that the still image file is a moving image-added still image file SF in which moving image data is incorporated in the header Hs.

The characteristic display method for displaying a still image based on the moving image-added image file SF on the monitor 20 is not limited to the multi-display (displayed list) or slideshow display on the selection page 60. For example, as shown in FIG. 13, when reproducing a still image on the monitor 20 of the camera 11, if there is a moving image associated with the reproduced still image, a structure that superimposes a mark 61 (associated image presence indication mark) indicating the presence of the moving image on the reproduced still image may be employed. It is obvious that a mark does not have to be displayed in a superimposed manner and may be displayed outside the still image. The design of the mark may also be varied as required. In this case, the control unit 41 checks the header Hs of the still image file that is subject to reproduction. When determining that a header Hs includes moving image data MD (or a moving image file MF), the control unit 41 has the still image reproduction unit 49 perform a process for displaying the still image and the mark 61 on the monitor 20.

The multi-display selection page 60 may be formed to display a list of only moving-image added still image files SF. That is, the determination unit 47 may determine whether or not the header Hs includes a moving image file and display a list of only the moving image-added still image files SF that include moving image files. In this case, only moving image-added still image files SF are displayed in a list on the selection page 60. Thus, when the selection subjects are always moving image-added still image files SF, unnecessary display of the simple still image files that would never be selection subjects is eliminated. This facilitates the selection of the moving image-added still image files SF. Further, as mentioned above, before reproducing a still image file, the moving image for a predetermined time before and after the capturing of the still image may be checked to confirm that the still image is the desired one. This reduces file selection errors in which it becomes apparent after reproduction that the opened still image file was not the desired one. This reduces unnecessary operations for re-selecting the correct still image file.

In the above-discussed embodiment, the moving image data retrieved in the moving image extraction process corresponds to the n seconds before and after a still image is captured. However, the n seconds may be a variable value. For example, the volume of the moving image data in the header Hs is known beforehand. Thus, the control unit 41 may compute from the resolution of a moving image the n seconds that a storage region of that volume may store. Then, in accordance with the computed n seconds, the control unit 41 may extract the moving image data corresponding to the n seconds before and after capturing the still image. Further, the extracted moving image data is not limited to the n seconds before and after the capturing of the still image. The moving image data may be extracted for only the n seconds before the capturing or for only the n seconds after the capturing. Further, the extracting time of the moving image data may differ before and after the capturing of the still image. In this case, the moving image data is extracted for the n second before the capturing or m seconds after the capturing (n<m or m>n).

In the above-discussed embodiment, the audio data used in the slideshow may be part of the audio data in the extracted moving image data. For example, the sound for only the n seconds before the capturing of a still image or the sound for only the n seconds after the capturing of a still image may be used.

In the above-discussed embodiment, the moving image data in the header Hs may be used to produce a display effect that shows moving images when switching still images. For example, a moving image based on the moving image data in a header Hs may be used as an image that fades in or fades out. In this case, when the time for switching to the next still image comes, which is based on the time measurement information of the time measurement unit 44, the moving image data for the latter n seconds is retrieved from the header Hs for the presently reproduced still image file, and moving image based on the retrieved moving image data for the latter n seconds fades out while it is being reproduced. Then, the moving image data for the former n seconds is retrieved from the moving image data in the header Hs of the next still image file, and moving image based on the retrieved moving image data for the former n seconds fades in while it is being reproduced. After fading in, the display is switched to the still image based on the next still image data. In this case, the moving image reproduction during fade in and fade out is performed by the control unit 41 instructing the moving image reproduction unit 50 to designate a still image file and reproduce moving images for the former n seconds or the latter n seconds. The display switching to the next still image after the fade in is performed by the control unit 41 instructing the still image reproduction unit 49 to designate a still image file and reproduce a still image based on the still image data. In this structure, the moving image reproduction unit 50 includes a fade processing unit for fading out or fading in the reproduced moving image. The fade processing unit reproduces a moving image based on moving image data while performing a fade process to produce a fade in and fade out display effect.

In the above-discussed embodiment, the moving image data may be included outside the header Hs in the still image file.

In the above-discussed embodiment, the image reproduction device is arranged in a camera. However, the image reproduction device may be arranged in an electronic device other than a camera. For example, the image reproduction device may be arranged in a digital photo frame. In this case, among the various circuits of the image processor 33 shown in FIG. 4, the image reproduction device includes the control unit 41, the determination unit 47, the multi-display processing unit 48, the still image reproduction unit 49, the moving image reproduction unit 50, and the sound reproduction unit 51. Such an image reproduction device is arranged in the digital photo frame. The digital photo frame includes a slot for a memory card. The memory card (in this case, the memory card is not limited to the memory card 36 for the camera 11 and includes a memory card to which the moving image-added image file SF is copied) storing a moving image-added still image file SF, which is generated when a still image is captured by the file generation device in the camera 11, is inserted into the slot of the digital photo frame. Based on the moving image-added still image file SF in the memory card 36, which is inserted in the slot, an MPU in the digital photo frame controls the image reproduction device (more specifically, sends instructions to some or all of the control unit 41, the determination unit 47, the multi-display processing unit 48, the still image reproduction unit 49, the moving image reproduction unit 50, and the sound reproduction unit 51) and executes the routine of FIG. 9 and the routine of FIG. 11. As a result, in the same manner as the camera 11 of the above-discussed embodiment, the multi-display selection page 60 or slide show is displayed on the monitor of the digital photo frame. It is obvious that the electronic device including the image reproduction device is not limited to the camera 11 and the digital photo frame and may be any electronic device that includes a display unit such as a monitor. Such an electronic device may be a cellular phone, a personal computer, a digital video camera, a video game, and the like.

The electronic device that includes the image generation device is not limited to the camera 11. However, it is preferable that the electronic device includes a camera function. Examples of such an electronic device include a camera-added cellular phone, a camera-added personal computer, a digital video camera and a camera-added video game. The electronic device is not necessarily required to have a camera as long as it has an input means such as an input port (input enabling connector) (for example, near field communication port such as a USB port, an HDMI port, and BLUETOOTH (registered trademark) to which a camera device may be connected in a communicable manner.

In the above-discussed embodiment, the file generation device is configured in the MPU 30 as software, for example, by having the MPU 30 execute a file generation program code stored in the non-volatile memory 38. Obviously, the file generation device may be realized by hardware formed by an ASIC etc. or through the cooperation of software and hardware.

In the above-discussed embodiment, the file generation device increases the resolution of the still image data recorded when capturing a moving image from the resolution of the moving image data. When performing such image capturing, the file generation device temporarily stops capturing moving images to capture a still image. This produces a period in which moving image capturing is not performed from when the moving image capturing is temporarily stopped to when the moving image capturing is restarted and divides the moving image data into two. To avoid such a situation, the file generation device may use the frame taken immediately before the moving image capturing is temporarily stopped and connect it to the moving image data retrieved when restarting moving image capturing to generate a single strand of moving image data.

In the above-discussed embodiment, for a moving image-added still image file SF, the moving image MI having a low resolution is displayed in the selection page 60 shown in FIG. 8. The moving image displayed in the selection page 60 may be repetitively displayed or displayed only once. When the moving image is displayed only once or displayed repetitively for a predetermined number of times, upon completion of the displaying of the moving image, part of a frame in the moving image may be displayed, and a thumbnail image of the still image file may be displayed.

In the above-discussed embodiment, the file generation device increases the resolution of the still image data recorded when capturing a moving image from the resolution of the moving image data. However, the resolution for the moving image data and the still image data may be the same. In such a case, when receiving an image capturing instruction from the user, the file generation device may extract a frame from the moving image data to generate a still image file. In this manner, when the file generation device generates a still image file and a moving image file with the same resolutions, the moving image data having the same resolution as the still image file is incorporated in the header Hs of the still image file.

In the above-discussed embodiment, the filer generation unit generates a still image file in which a moving image file is incorporated. However, as long as at least the moving image data is included, the incorporated data does not have to be in the form of a moving image file.

The illustrated and non-restrictive examples of elements may be associated with the claims as described below. The monitor 20 is one example of a display unit. The selection button 24 and the enter button 25 form a selection means. The imaging element 31 forms an image capturing means. The memory card 36 is one example of a storage means. The control unit 41 forms an information retrieval means. The still image generation unit 42 forms an image retrieval means. The moving image extraction processing unit 45 forms a moving image extraction means. The file generation unit 46 forms a file generation means. The multi-display processing unit 48 forms a display control means. The still image reproduction unit 49 forms a control means and a reproduction means. The sound reproduction unit 51 forms a control means and an audio data retrieval means. The moving image-added still image file SF is one example of a still image file. The still image header Hs is one example of a header. Still image related information is one example of information related to still image data.

Embodiments of the present invention have been described in relation with the drawings. However, the present invention is not limited to the foregoing description and changes may be made within the scope and equivalence of the appended claims.

1. A still image file data structure comprising:
a single still image file incorporating:
still image data;
information related to the still image data; and
moving image data associated with the still image data.

2. The still image file data structure according to claim 1, wherein still image data of a still image captured when a camera including a capturing means is capturing a moving image, the information related to the still image data, and moving image data of the moving image captured by the capturing means during a capturing period including a capturing time of the still image are incorporated in the single still image file.

3. The still image file data structure according to claim 1, wherein the moving image data has a data volume that is smaller than a data volume of the still image data, and the moving image data includes a plurality of frame images; and
moving image data, which includes the plurality of frame images and audio data synchronized with the plurality of frame images, is incorporated in the still image file.

4. The still image file data structure according to claim 1, wherein the information related to the still image data is included in a header in the still image file, and the moving image data is incorporated in the header.

5. An image file generation device for use with an image capturing means capable of capturing a still image while capturing a moving image, the image file generation device generating a still image file, the image file generation device comprising:
an image retrieval means for retrieving moving image data of the moving image captured by the image capturing means and for retrieving still image data of the still image captured by the image capturing means while capturing the moving image;
an information retrieval means for retrieving information related to the still image data that is retrieved; and
a file generation means for generating a single still image file including the information, the moving image data, and the still image data.

6. The image file generation device according to claim 5, wherein the image retrieval means retrieves the still image data of the still image captured at a capturing image time in a capturing period of the moving image data that is retrieved, the file generation device further comprising:
a moving image extraction means for extracting, from the moving image data, moving image data corresponding to a predetermined period including the capturing time of the still image data;
wherein the file generation means incorporates the moving image data corresponding to the predetermined period that is extracted in the still image file.

7. The image file generation device according to claim 5, wherein the moving image data has a resolution that is lower than that of the still image data, and the moving image data is in correspondence with part of a capturing period of the moving image that includes a capturing time of the still image data.

8. An image reproduction device for reproducing an image based on a still image file having the data structure described in claim 3, the image reproduction device comprising:
a display unit;
a speaker;
a selection means for selecting a still image file that is to be reproduced;
an audio data retrieval means for retrieving audio data from the moving image data of the selected still image file; and
a control means for reproducing the still image data in the selected still image file as an image displayed on the display unit and reproducing the audio data at a reproducing timing synchronized with the still image data.

9. The image reproduction device according to claim 8, wherein when the selection means selects a plurality of still image files to perform a slideshow, the audio data retrieval means retrieves audio data from the moving image data included in the selected plurality of still image files, the control unit performs the slideshow by sequentially displaying a plurality of still images on the display unit based on the still image data included in each of the selected plurality of still image files, and the control unit reproduces sound with the speaker using the audio data incorporated in the still image file that incorporates the still image data being used for display.

10. An image reproduction device comprising:
a storage means for storing a plurality of still image files including at least one still image file having the data structure according to claim 1;
a display unit;
a display control means for generating a selection page displaying in a list a plurality of images based on the plurality of still image files read from the storage means and displaying the selection page on the display unit;
a selection means for selecting one or more still images that are to be reproduced from the plurality of images in the displayed list on the selection page; and
a reproduction means for performing image reproduction to display the one or more still images selected by the selection means on the display unit;
wherein among the still image files used for the displayed list, for a still image file including moving image data, the display control means displays a moving image based on the moving image data as an image in the displayed list.

11. An electronic camera including the image file generation device according to claim 5.

12. An electronic camera including one or both of the image reproduction device according to claim 10.

13. An electronic camera including the image reproduction device according to claim 8.

14. An electronic camera including one or both of the image file generation device according to claim 5 and an image reproduction device comprising:
a display unit;
a speaker;
a selection means for selecting a still image file that is to be reproduced;
an audio data retrieval means for retrieving audio data from the moving image data of the selected still image file; and
a control means for reproducing the still image data in the selected still image file as an image displayed on the display unit and reproducing the audio data at a reproducing timing synchronized with the still image data.

15. An electronic camera including the image reproduction device according to claim 10 and an image file generation device comprising:
an image retrieval means for retrieving moving image data of the moving image captured by the image capturing means and for retrieving still image data of the still image captured by the image capturing means while capturing the moving image;
an information retrieval means for retrieving information related to the still image data that is retrieved; and
a file generation means for generating a single still image file including the information, the moving image data, and the still image data.
